(19) United States
(12) Patent Application Publication
(10) Pub. No.: US 2009/0069974 A1
(43) Pub. Date: Mar. 12, 2009

(54) DISPLAY CONTROL DEVICE

(75) Inventors: Kazushi Kawase, Kanagawa (JP); Takahiro Kudo, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/814,740

(22) PCT Filed: Nov. 2, 2005
(86) PCT No.: PCT/JP2005/020211

§ 371 Date: Oct. 5, 2007

(30) Foreign Application Priority Data
Jan. 27, 2005 (JP) 2005-019570

(51) Int. Cl. B60R 11/04

(52) U.S. Cl. 701/36

(57) ABSTRACT

It is an object of the present invention to provide a display control device that can assist a driver to check a blind spot more appropriately. In a control device 16 to be mounted on a vehicle to control left front and right front obstruction sensors 11a and 11b for detecting an obstacle ahead of the vehicle, a left camera 12a mounted on left side part of the vehicle to take a video indicative of a view from the vehicle, a right camera 12b mounted on right side part of the vehicle to take a video indicative of a view from the vehicle, and a display device 13 for displaying a video on a screen, the CPU 16b has the display device 13 display, on the basis of detection results of the left front and right front obstruction sensors 11a and 11b, a video taken by the camera 12a or 12b opposite to a direction in which an obstacle is out of line.

### TECHNICAL FIELD OF THE INVENTION

This invention relates to a display control device for controlling a monitor to display a video on its screen.

### DESCRIPTION OF THE RELATED ART

A device, which has been known as a conventional display control device, displays a video from a camera housed in a vehicle side mirror, to assist a driver to check driver blind spot in front of the vehicle (see, a patent document 1).

Patent document 1: Jpn. unexamined patent publication No. 2000-272418 (pages 3-4, FIG. 3)

### DISCLOSURE OF THE INVENTION

### Problems to be Solved by the Invention

The conventional display control device has a problem that the driver cannot check blind spot due to an obstacle ahead of the camera.

This present invention provides a display control device for assisting a driver to check the blind spot more appropriately.

### Means for Solving the Problems

The display control device according to the present invention comprises a controller for controlling a monitor to display a right front view from a vehicle upon an obstacle being at a left front from the vehicle, and to display a left front view from the vehicle upon an obstacle being at a right front from the vehicle, on the basis of data on whether or not an obstacle is at the left front, and data on whether or not an obstacle being at the right front.

This display control device can assist a driver to check the blind spot more appropriately. “Data on whether or not an obstacle is” is for a computer determining whether or not there is an obstacle. This data can be outputted at only one of a time when there is an obstacle and a time when there is no obstacle. “Data on whether or not an obstacle is at the left front” and “data on whether or not an obstacle is at the right front” can be outputted by respective sensors, or outputted by one sensor. In the latter case, the sensor can be mounted on a center front portion of the vehicle to tarn a detecting surface. The video indicative of a right front view from the vehicle and the video indicative of a left front view from the vehicle can be outputted by the camera mounted on the right and the camera mounted on left sides of the vehicle respectively. These videos can be a separated video taken by one camera.

In this display control device, the controller controls the monitor to display the right front view upon an obstacle being at the left front and the vehicle being in a traffic jam, and to display the left front view upon an obstacle being at the left front and the vehicle being in a traffic jam, on the basis of data on whether or not the vehicle is in a traffic jam.

This display control device starts to select the video automatically upon the vehicle in a traffic jam—which tends to increase the blind spot in front of the vehicle—to assist a driver to check the blind spot more appropriately in the traffic jam. “Data on whether or not the vehicle is in a traffic jam” is for a computer determining data on whether or not the vehicle is in a traffic jam. This data includes data received from Vehicle Information and Communication System (VICS) or other infrastructure system, and data calculated from navigation information and produced by devices mounted on the vehicle.

The display control device according to the present invention comprises a controller for controlling a monitor to display a right front view from a vehicle upon a road curve being at a right front from the vehicle, and to display a left front view from the vehicle upon a road curve being at a light front from the vehicle, on the basis of data on whether or not a road curve is at the left front, and data on whether or not a road curve being at the right front.

This display control device can assist a driver to check the blind spot more appropriately. “Data on whether or not a road curve is at the left front” and “data on whether or not a road curve being at the right front” is for a computer determining whether or not there is a road curve. This data can be outputted at only one of a time when there is a road curve and a time when there is no road curve.

In this display control device, the controller controls the monitor to display the right front view upon a road curve being at the right front and the vehicle being in a traffic jam, and to display the left front view upon a road curve being at the light front and the vehicle being in a traffic jam, on the basis of data on whether or not the vehicle is in a traffic jam.

This display control device starts to select the video automatically upon the vehicle in a traffic jam—which tends to increase the blind spot in front of the vehicle—to assist a driver to check the blind spot more appropriately in the traffic jam.

### ADVANTAGEOUS EFFECT OF THE INVENTION

The present invention provides a display control device which can assist a driver to check the blind spot more appropriately.

### BRIEF DESCRIPTION OF THE DRAWINGS

FIG. 1 is a diagram showing the hardware construction of the operation support system of the first embodiment of the present invention.

FIG. 2 is a top view showing a vehicle on which the operation support system shown in FIG. 1 is mounted.

FIG. 3 is a flow chart showing an operation of the operation support system shown in FIG. 1.

FIG. 4(a) is a top view showing the vehicle shown in FIG. 2 and its vicinity under the condition that a vehicle just ahead of the vehicle shown in FIG. 2 is out of line to the left in some degree. FIG. 4(b) is a top view showing the vehicle shown in FIG. 2 and its vicinity under the condition that a vehicle just ahead of the vehicle shown in FIG. 2 is out of line to the right in some degree.

FIG. 5 is a front view showing a display device of the operation support system shown in FIG. 1.

FIG. 6 is a diagram showing the hardware construction of the operation support system of the second embodiment of the present invention.

FIG. 7 is a flow chart showing an operation of the operation support system shown in FIG. 6.

FIG. 8(a) is a top view showing a vehicle and its vicinity, the vehicle having mounted thereon the drive assistance system shown in FIG. 6, and being traveling around a right-hand curve. FIG. 8(b) is a top view showing a vehicle and its vicinity, the vehicle having mounted thereon the drive assistance system shown in FIG. 6, and being traveling around a left-hand curve.

### EXPLANATION OF THE REFERENCE NUMERALS

11a: left front obstruction sensor
11b: right front obstruction sensor
12a: left camera
12b: right camera
13: display device (monitor)
16: control device (display control device)
16a: ROM (controller)
16b: CPU (controller)
16c: RAM (controller)
54: control device (display control device)
54a: ROM (controller)
90: vehicle
100: vehicle (obstacle)
110a: right-hand curve (curve)
110b: left-hand curve (curve)

### DESCRIPTION OF THE PREFERRED EMBODIMENTS

The first and second embodiments according to the present invention are described hereinafter with reference to accompanying drawings.

### First Embodiment

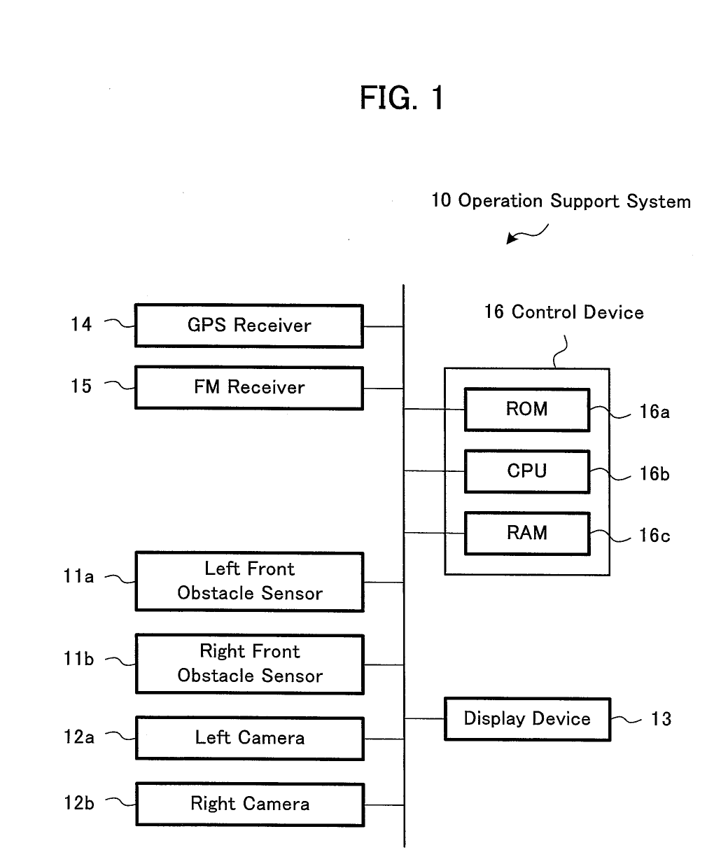

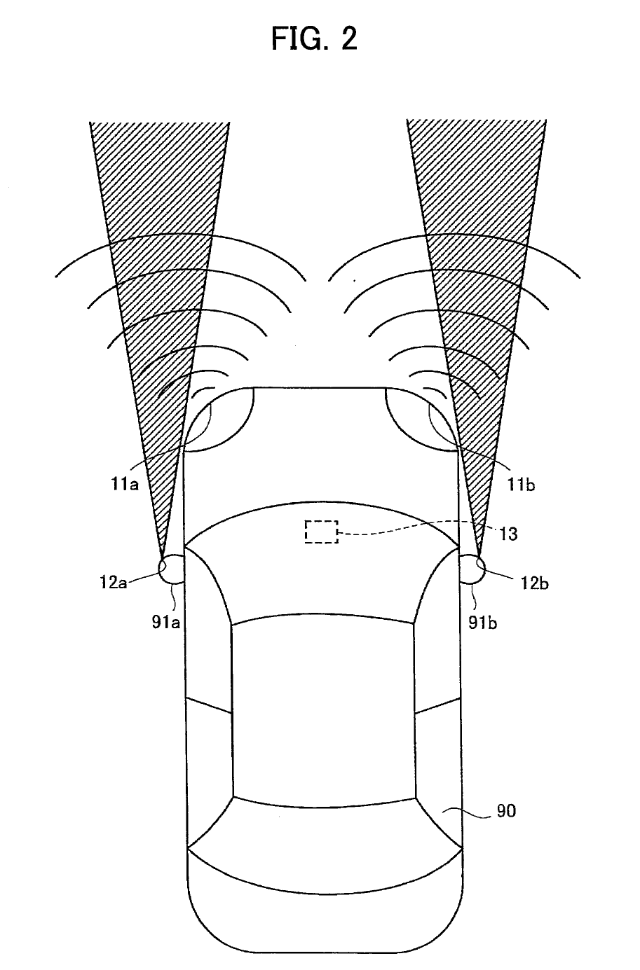

FIGS. 1 and 2 illustrates the construction of the operation support system 10 of the first embodiment.

In the operation support system 10, a left front obstruction sensor 11a is mounted on left front part of a vehicle 90 to detect an obstacle ahead of the vehicle 90. A right front obstruction sensor lib is mounted on right front part of a vehicle 90 to detect an obstacle ahead of the vehicle 90. A left camera 12a is housed in a left side mirror 91a of the vehicle 90 to take a video indicative of a left view from the vehicle 90, more specifically, video indicative of a left front view from the vehicle 90. A right camera 12b is housed in a right side mirror 91b of the vehicle 90 to take a video indicative of a right view from the vehicle 90, more specifically, a video indicative of a right front view from the vehicle 90. A display device 13, as a monitor, is built into an instrumental panel (not shown) of the vehicle 90 to display a video on its screen. A Global Positioning System (GPS) receiver 14 is mounted on the vehicle 90 to receive signals from artificial satellites. The signals are useful to calculate latitude and longitude of the vehicle 90. A frequency modulation (FM) receiver 15 is mounted on the vehicle 90 to receive traffic information from Vehicle Information and Communication System (VICS), and to demodulate the received traffic information. A control device 16 controls each part of the operation support system 10 mounted on the vehicle 90.

Here, each of the left front obstruction sensor 11a and the right front obstruction sensor lib may be constituted by a sonar, an ultra wide band sensor (UWB), or the like.

The control device 16, which constitutes a display control device, has a read only memory (ROM) 16a, a central processing unit (CPU) 16b, and a random access memory (RAM) 16c, to control the display device 13 to display a video on the screen. The ROM 16a memorizes various types of control programs. The CPU 16b executes the control programs memorized in the ROM 16a to perform functions defined by the control programs. The RAM 16c memorizes various data processed by the CPU 16b.

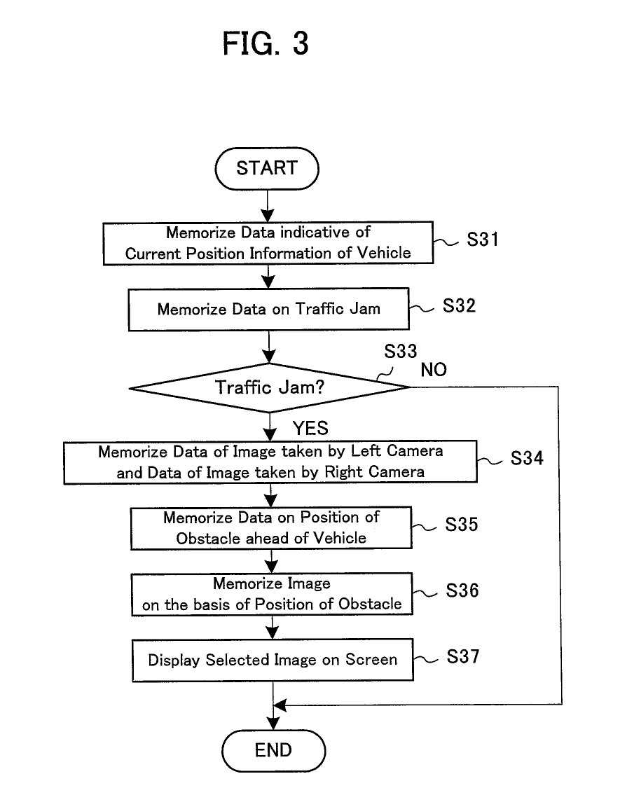

FIG. 3 illustrates the routine of the operation support system 10.

In step S31, the CPU 16b controls the RAM 16c to memorize the current position data received by the GPS receiver 14 and traffic jam information—data on whether or not the traffic is heavy—. For memorizing the traffic jam information, the VICS information is received and demodulated by the FM receiver 15.

In step S33, the CPU 16b determines whether or not the vehicle 90 is in a traffic jam on the basis of the current position data and the traffic jam information that are memorized in the RAM 16c in the step S32.

If the determination in step S33 indicates that the vehicle 90 is not in a traffic jam, the CPU 16b breaks and restarts the routine shown in FIG. 3.

On the other hand, in step S34, if the determination in step S33 indicates that the vehicle 90 is in a traffic jam, the CPU 16b controls the RAM 16c to memorize video from the left cameras 12a and video from the right cameras 12b.

In step S35, the CPU 16b detects a position of an obstacle ahead of the vehicle 90, on the basis of detection results of the left front sensor 11a—data on whether or not an obstacle is at a left front from the vehicle 90—and detection results of the right front sensor 11b—data on whether or not an obstacle is at a right front from the vehicle 90. The CPU 16b controls the RAM 16c to memorize the detected position.

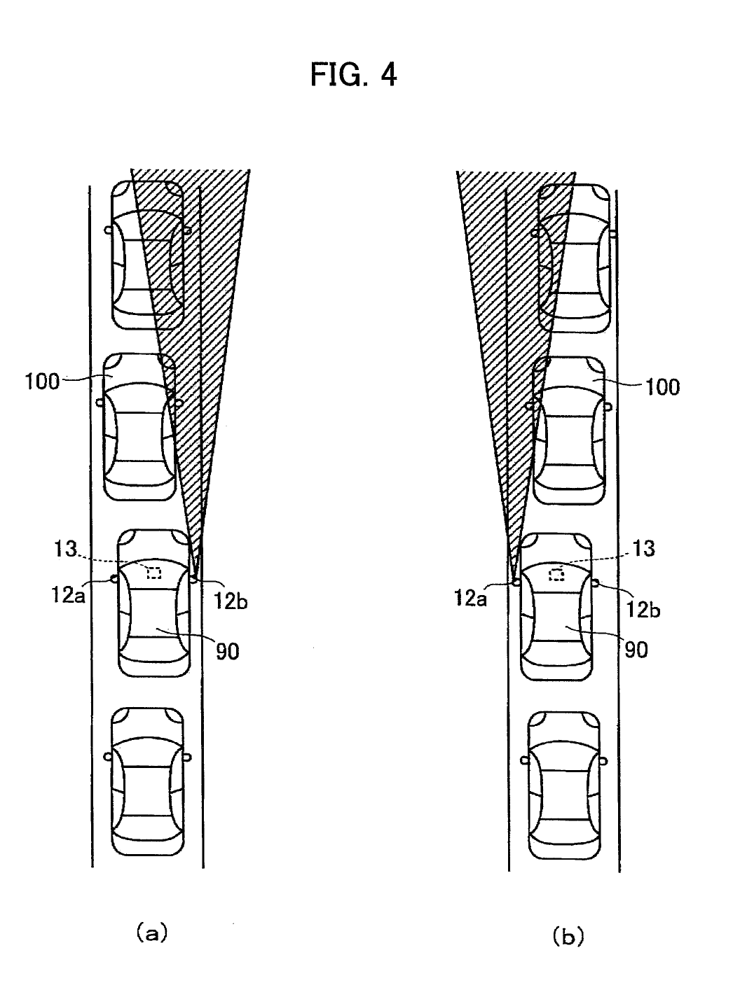

In step S36, the CPU 16b selects one of the videos memorized in the RAM 16c in the step S34, on the basis of the detection results memorized in the RAM 16c in the step S35. More specifically, the selected video is taken by one of the left cameras 12a and the right cameras 12b that is on left-right-reverse side out of line to which the obstacle ahead of the vehicle 90 is. In step S37, the CPU 16b controls the display device 13 to display the selected video on the screen. Accordingly, the CPU 16b controls the display device 13 to display the video from the right camera 12b on the screen if a vehicle 100, as the obstacle, ahead of the vehicle 90 is out of line to the left in some degree as shown in FIG. 4(a). On the other hand, the CPU 16b controls the display device 13 to display the video from the left camera 12a on the screen if the vehicle 100 ahead of the vehicle 90 is out of line to the right in some degree as shown in FIG. 4(b). Thus, it is understood that “controller” is constituted by the ROM 16a, the CPU 16b and the RAM 16c, for selecting a view from a camera that is on left-right-reverse side out of line to which the obstacle is, on the basis of the detection results of the left front and right front obstruction sensors 11a and 11b.

Additionally, the CPU 16b breaks and restarts the routine shown in FIG. 3 after controlling the display device 13 to display the video on the screen in the step S37.

From the foregoing description, it is understood that the control device 16 can assist a driver to check the blind spot more appropriately by having the display device 13 display a video taken by the right camera 12b on the screen when an obstacle is at a left front from the vehicle 90, and having the display device 13 display a video taken by the left camera 12a on the screen when an obstacle is at a right front from the vehicle 90.

The control device 16 can assist a driver to check the blind spot, which tends to be increased by the traffic jam, by reason that the CPU 16b automatically starts to select the videos from the left and right cameras 12a and 12b when the vehicle 90 is in a traffic jam. Additionally, the control device 16 may start to select the videos on the basis of another condition different from a condition that the vehicle 90 is in a traffic jam. For example, the control device 16 may start to select the videos on the basis of user's manual operation.

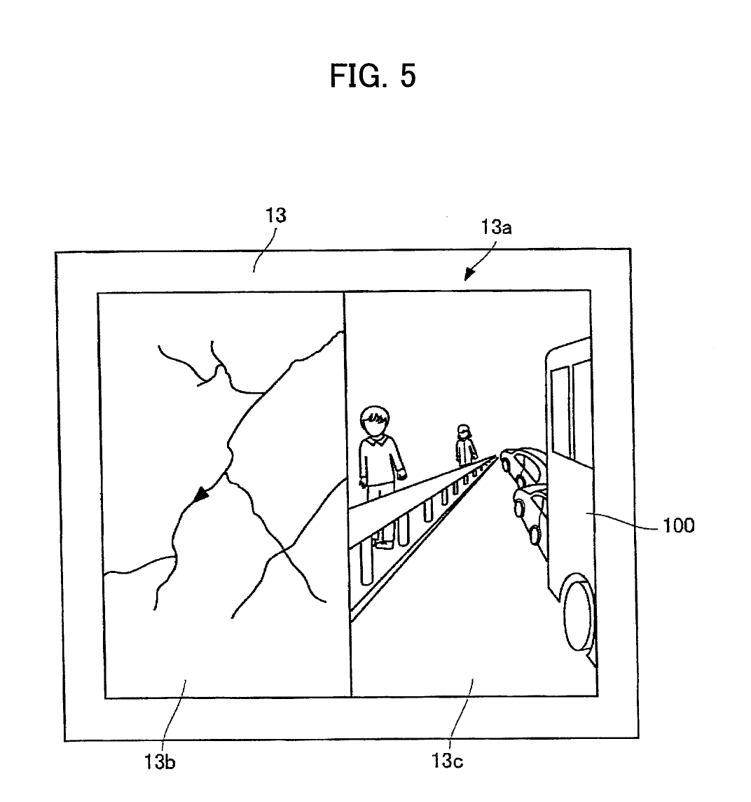

The control device 16 can have the display device 13 display the video taken by the left camera 12a or the right camera 12b more clearly and widely, even if a video 13b indicative of navigation information of the vehicle 90 (see, FIG. 2) and a video 13c taken by the left camera 12a (see, FIG. 2) or the right camera 12b (see, FIG. 2) are simultaneously displayed on the screen 13a small in size, by reason that the videos 13c taken by the left camera 12a (see, FIG. 2) and the right camera 12b (see, FIG. 2) are not simultaneously displayed on the screen 13a by the display device 13. Additionally, the view of FIG. 5 shows a video 13c taken by the left camera 12a under the condition that a bus 100 (see, FIG. 4) ahead of the vehicle 90 is out of line to the right.

As a result of the fact that the operation support system 10 is applied to a vehicle including a right camera 12b previously housed in a right side mirror 91b, and a left camera 12a previously housed in a left side mirror 91a, the operation support system 10 can be reduced in production cost. The left camera 12a may be located at left side part of the vehicle 90 in place of the left side mirror 91a without being housed in the left side mirror 91a, while the right camera 12b may be located at right side part of the vehicle 90 without being housed in the right side mirror 91b.

In this embodiment, various functions are realized by the control device 16 on the basis of various control programs memorized in the ROM 16a. However, the functions may be realized by only hardware elements without control programs.

In this embodiment, the videos taken by the right and left cameras 12a and 12b are temporarily memorized in the RAM 16c. Then, the videos memorized in the RAM 16c are selectively displayed on the screen by the display device 13. However, the control device 16 may have the display device 13 selectively display the videos on the screen on the basis of another method. For example, the control device 16 may have the display device 13 selectively display the videos from the left and right cameras 12a and 12b by electrically connecting the display device 13 with either the left camera 12a or the right camera 12b.

### Second Embodiment

The construction of the operation support system of the second embodiment is firstly described hereinafter.

The constitution elements of the operation support system of the second embodiment the same as those of the operation support system 10 (see FIG. 1) of the first embodiment is not described in detail but bears the same reference numbers as those of the operation support system of the first embodiment.

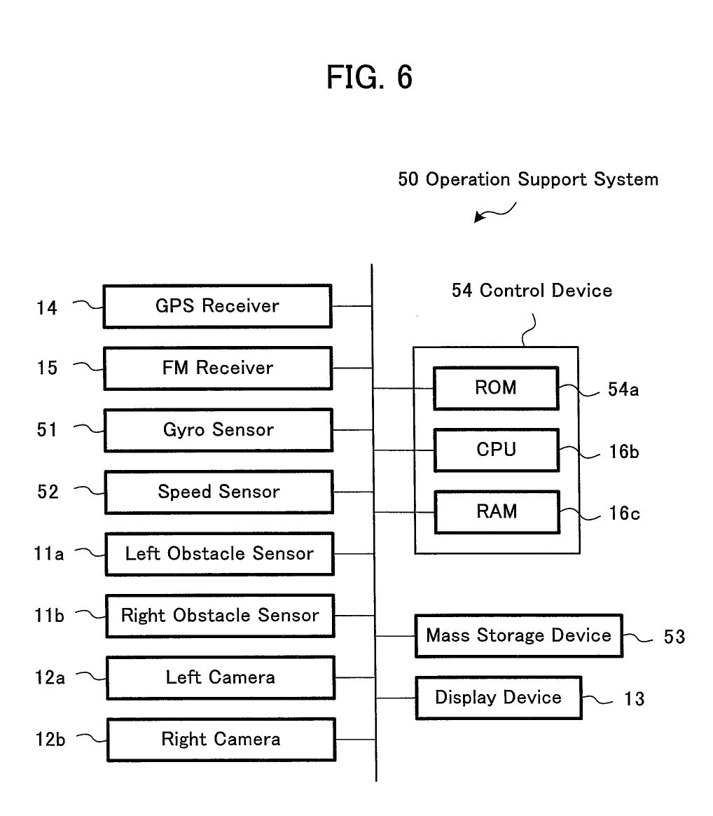

As shown in FIG. 6, the operation support system 50 of the second embodiment is the same in construction as the operation support system 10 of the first embodiment with the exception of the fact that the operation support system 50 further comprises a gyro sensor 51 which is mounted on a vehicle 90 to detect a direction of a vehicle 90, a vehicle speed sensor 52 which is mounted on the vehicle 90 to detect a vehicle speed of the vehicle 90, a mass storage device 53 which is mounted on the vehicle 90 to memorize road map information, and constituted by a hard disc drive (HDD) or the like, and a control device 54 which is mounted on the vehicle 90 in place of the control device 16 (see FIG. 1) to control all parts of the operation support system 50.

Here, the control device 54 is the same in construction as the control device 16 with the exception of the fact that the control device 54 includes, in place of the ROM 16a (see FIG. 1), a read only memory (ROM) 54a for memorizing various control programs. The control device 54 constitutes a display control device.

The operation of the operation support system 50 is then described hereinafter.

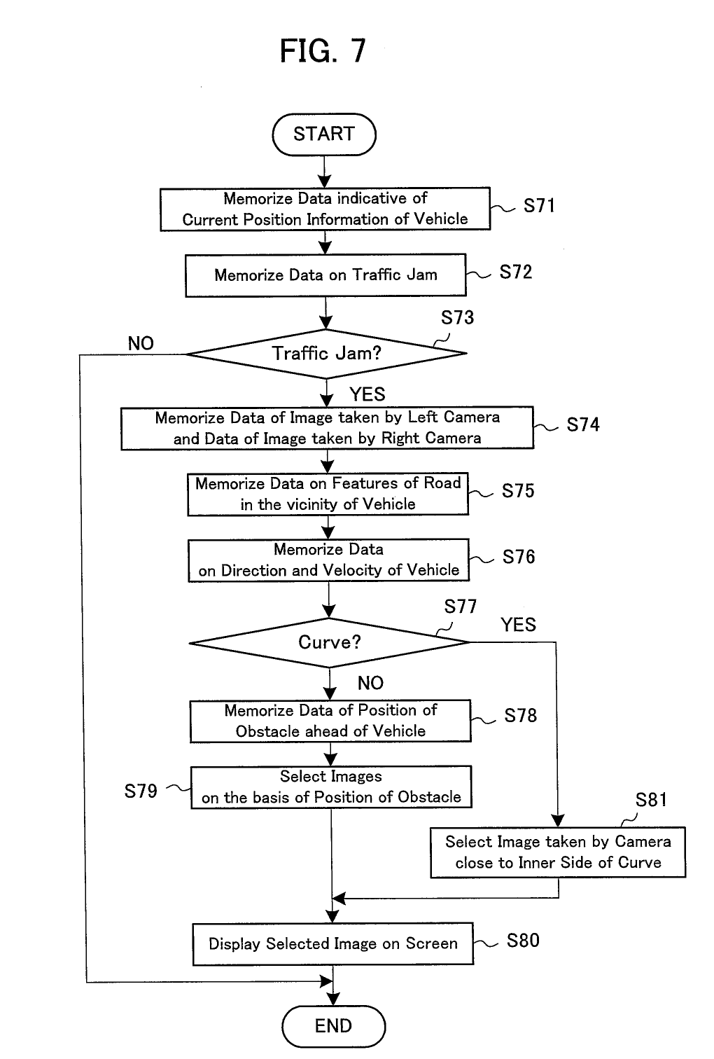

As shown in FIG. 7, the CPU 16b processes data in steps S71, S72, S73, and S74 which are the same in routine as the respective steps S31, S32, S33, and S34 (see FIG. 3).

In step S75, the CPU 16b obtains the shape of the road around the vehicle 90 on the basis of road map information memorized in the mass storage device 53 and the current position information memorized in the step S71 in the RAM 16c.

In step S76, the CPU 16b memorizes information indicative of the direction of the vehicle 90 detected by the Gyro sensor 51, and information indicative of the vehicle speed of the vehicle 90 detected by the vehicle speed sensor 52 in the RAM 16c.

In step S77, the CPU 16b judges, on the basis of the current position memorized in the RAM 16c in the step S71, the shape of the road memorized in the RAM 16c in the step S75, and the direction and vehicle speed of the vehicle 90 memorized in the RAM 16c in the step S76, whether or not the vehicle 90 is traveling around a curve. Here, the judgment results obtained in the step S77 constitute data on whether or not the vehicle 90 is traveling around a curve.

When the CPU 16b judges in the step S77 that the vehicle 90 is not traveling around a curve, the CPU 16b proceeds to steps S78, S79, and S80 which are the same in routine as the respective steps S35, S36, and S37 (see FIG. 3).

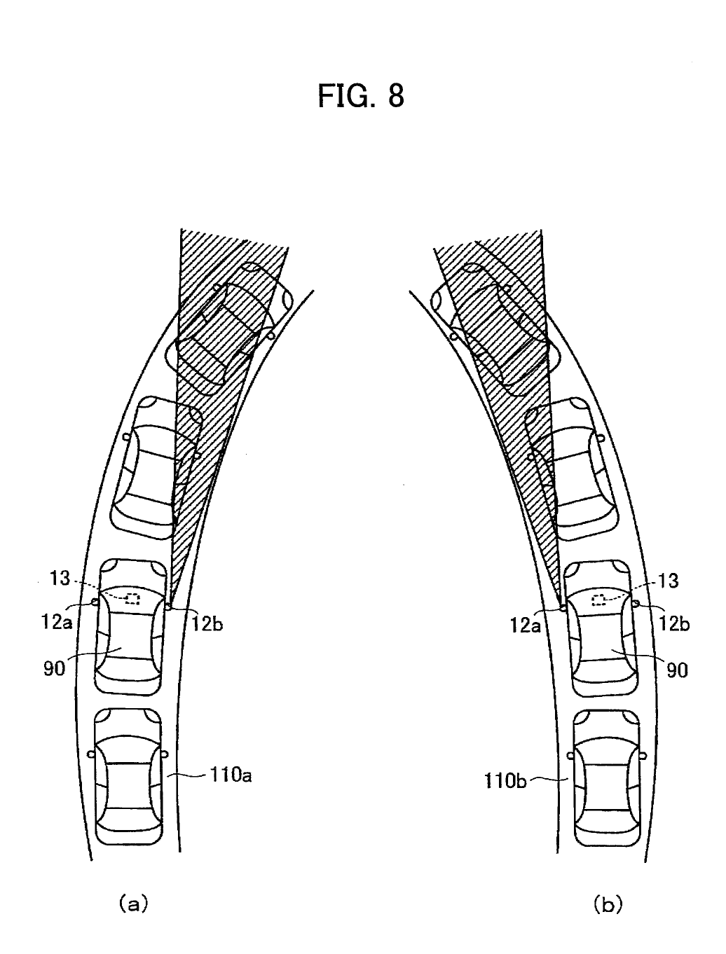

When, on the other hand, the CPU 16b judges in the step S77 that the vehicle 90 is traveling around a curve, the CPU 16b selects (in step S81), from videos memorized in the RAM 16c, a video taken by a camera close to an inner side of a curve that the vehicle 90 is now traveling along, and has the display device 13 display the selected video on its screen (in step S80). More specifically, when the vehicle 90 is traveling along a right-hand curve, the CPU 16b has the display device 13 display a video taken by the right camera 12a as shown in FIG. 8(a). When, on the other hand, the vehicle 90 is traveling along the left-hand curve, the CPU 16b has the display device 13 display a video taken by the left camera 12a as shown in FIG. 8(b). Thus, it is understood that the ROM 54a, the CPU 16b, and the RAM 16c collectively constitute control means for selecting a view from a camera close to an inner side of a curve that the vehicle 90 is now traveling along.

The CPU 16b has the display device 13 display the video in the step S80, then completes and restarts series of data processing shown by the flow chart of FIG. 7.

From the foregoing description, it is understood that the drive assistance device of the present invention can assist a driver to check a blind spot of a traveling direction more appropriately in comparison with the conventional drive assistance device by reason that the control device 16 has the display device 13 display the video taken by the right camera 12b when the vehicle 90 is traveling along a right-hand curve, and has the display device 13 display the video taken by the left camera 12a when the vehicle 90 is traveling along a left-hand curve.

### INDUSTRIAL APPLICABILITY OF THE PRESENT INVENTION

From the foregoing description, it is understood that the display control device of the present invention has advantageous effects of assisting a driver to check a blind spot of a traveling direction of the vehicle more appropriately, and is useful as a control device and the like for assisting a driver to check a blind spot of a traveling direction of the vehicle when the vehicle is in a traffic jam.

What is claimed is:

1. A display control device comprising:
a controller for controlling a monitor to display a right front view from a vehicle upon an obstacle being at a left front from the vehicle, and to display a left front view from the vehicle upon an obstacle being at a right front from the vehicle, on the basis of data on whether or not an obstacle is at the left front, and data on whether or not an obstacle being at the right front.

2. A display control device of claim 1, in which the controller controls the monitor to display the right front view upon an obstacle being at the left front and the vehicle being in a traffic jam, and to display the left front view upon an obstacle being at the left front and the vehicle being in a traffic jam, on the basis of data on whether or not the vehicle is in a traffic jam.

3. A display control device comprising:
a controller for controlling a monitor to display a right front view from a vehicle upon a road curve being at a right front from the vehicle, and to display a left front view from the vehicle upon a road curve being at a light front from the vehicle, on the basis of data on whether or not a road curve is at the left front, and data on whether or not a road curve being at the right front.

4. A display control device of claim 3, in which the controller controls the monitor to display the right front view upon a road curve being at the right front and the vehicle being in a traffic jam, and to display the left front view upon a road curve being at the light front and the vehicle being in a traffic jam, on the basis of data on whether or not the vehicle is in a traffic jam.
